(19) United States
(12) Patent Application Publication
(10) Pub. No.: US 2009/0106897 A1
(43) Pub. Date: Apr. 30, 2009

(54) WHEEL MOUNTING DEVICE AND PLATE AND METHOD

(76) Inventor: Lawrence Harrow, Commerce, CA (US)

Correspondence Address: CONNORS ASSOCIATES, 1600 DOVE ST, SUITE 220, NEWPORT BEACH, CA, 92660, US

(21) Appl. No.: 11/928,208

(22) Filed: Oct. 30, 2007

(51) Int. Cl. A47C 19/02; B60B 33/00; B23P 11/00

(52) U.S. Cl. 5/200.1; 16/45; 5/279.1; 16/29; 29/525.01

(57) ABSTRACT

A wheel-mounting device comprises a pair of attached plates each having a substantially flat surface. The flat surface of each plate has therein an elongated indentation including an inwardly projecting dimple element. The dimple elements hold in position a shaft of a wheel. The flat surfaces abut and the indentations are aligned and face each other to form a cavity with an open entryway that receives the shaft of the wheel.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

### BACKGROUND

Bed frames are commonly used structures to support above a floor a box-spring and mattress. These bed frames include legs that frequently have at each of their terminal ends a wheel assembly, which enables the bed frame to be moved around. Typically, they are made of a number of pieces that are shipped assembled or unassembled and then assembled by an installer at the location where the bed frame is to be used. In many prior art bed frames the pieces are frequently numerous and sometimes require the use of tools to connect them together. This adds cost to manufacturing, shipping and installation. Ideally, a bed frame and wheel assembly should have a minimum number of pieces, be easy to package and ship, and be conveniently and quickly assembled.

My wheel-mounting device has one or more of the features depicted in the embodiment discussed in the section entitled “DETAILED DESCRIPTION OF ONE ILLUSTRATIVE EMBODIMENT.” The claims that follow define my wheel-mounting device and method of manufacturing, distinguishing them from the prior art; however, without limiting the scope of my wheel-mounting device and method of manufacturing as expressed by these claims, in general terms, some, but not necessarily all, of their features are:

One, my wheel-mounting device includes a pair of plates that are connected together to hold between them a shaft of a wheel assembly. Each plate may have a substantially flat surface, and the flat surface of each plate has therein an elongated indentation and each indentation has an open external end portion at an edge of the plate in which the indentation is situated. The plates are attached together with the flat surfaces abutting and the indentations being aligned and facing each other to form a cavity upon attachment of the plates. The cavity may have a substantially cylindrical configuration with a predetermined substantially uniform diameter. The open external end portions of the indentations form at an outer end of the cavity an open entryway along the edges of the abutting and attached plates. The plates may be substantially mirror images. Each plate may comprise a carrier portion and a wing portion along an outer edge of the carrier portion, and each wing member may be substantially at 90 degrees with respect to the plate. The wing member facilitates detachably connecting the wheel-mounting device to a bed frame. A portion of the attached plates may form a stop member at an inner end of the cavity opposite the open entryway to limit inward movement lengthwise of the shaft.

Two, each indentation includes an inwardly projecting dimple element. The dimple elements may be aligned along a common line and point towards each other. Upon attachment of the plates, the dimple elements are separated by a predetermined distance to enable these elements to hold a shaft of a wheel within the cavity. The predetermined distance is such to enable the dimple elements to prevent the wheel shaft from moving lengthwise out the open entryway after the shaft has been placed within the cavity.

Three, the cavity and the wheel shaft are sized and configured to be interactive. The wheel assembly may be, for example, of the swivel type, which has a wheel mounted between arms of a yoke and an elongated shaft extending outward from the yoke's crosspiece. The shaft may include an upper end portion comprising an enlarged element having a width dimension slightly greater than the predetermined distance between the dimple elements. The shaft may have a predetermined length that enables a lower end to extend from the open entryway. The enlarged element may be at or nearby the inner end of the cavity and inward of the dimple elements after the plates are attached to hold the shaft within the cavity and prevent movement lengthwise out the open entryway. The shaft may include a substantially cylindrical main body portion with a diameter less than the predetermined distance between the dimple elements.

Four, the enlarged element is positioned along the main body of the shaft so upon being positioned within the cavity between the assembled plates, it is inward of the dimple elements to hold the shaft within the cavity and prevent movement lengthwise out the open entryway. The enlarged element may be a substantially annular member having a diameter greater than the diameter of the main body portion and less than the predetermined diameter of the cylindrical cavity. The lower end of the shaft may have a cylindrical configuration with a diameter about equal to the diameter of the cavity. The dimple elements function as a bearing for the shaft and the lower cylindrical end also functions as a bearing for the shaft.

These features are not listed in any rank order nor is this list intended to be exhaustive.

My method of manufacturing my wheel-mounting device comprises at least two steps. First, a pair of plates is provided that are substantially mirror images. Each plate has a substantially L-shaped configuration and is manufactured from substantially flat metallic sheets punch pressed and bent into the L-shaped configuration in accordance with conventional metal forming processes. Each plate includes a wall with an indentation therein, and each indentation includes an inwardly projecting dimple element. Each indentation has an open end along an edge of the plate. Second, the plates are fastened together with the walls of the plates abutting each other and the indentations aligned to form a cavity having along the edges an entryway adapted to receive a shaft of a wheel. The dimples may be aligned opposite each other and are spaced apart a predetermined distance to hold the shaft of the wheel in the cavity. The shaft may be inserted into the entryway of the cavity after fastening the plates together. Or, the shaft may be placed between the plates and then the plates are fastened together.

### BRIEF DESCRIPTION OF THE DRAWING

One embodiment of my wheel-mounting device, a bed using this device, and methods are shown in the accompanying drawing, which is for illustrative purposes only. This drawing includes the following figures (Figs.), with like numerals indicating like parts:

FIG. 1 is a side view, with sections broken away, of a prior art wheel-mounting device with a spilt ring washer to hold a swivel wheel assembly in place.

FIG. 1A is perspective view of the spilt ring washer shown in FIG. 1.

FIG. 2 is a perspective view of one embodiment of my wheel-mounting device.

FIG. 2A is a partial fragmentary view of a plate used in the one embodiment of my wheel-mounting device shown in FIG. 2, with the shaft of a swivel wheel assembly seated in an indentation in the plate.

FIG. 3 is a partially exploded perspective view of the embodiment shown in FIG. 2 looking at the left hand plate side of my wheel-mounting device.

FIG. 4 is a perspective view of disconnected plates looking at the internal surface of the plates.

FIG. 5 is a partially exploded perspective view of the wheel device shown in FIG. 2 looking at the right hand plate side of my wheel-mounting device.

FIG. 6 is a side view, with sections broken away, of the wheel device shown in FIG. 2, illustrating a pair of dimple elements holding in place the shaft of a swivel wheel assembly seated in a cavity formed by the indentations.

FIG. 6A is a cross sectional view taken along line 6A-6A of FIG. 6.

FIG. 7 is a perspective view of a portion of a bed frame using my wheel-mounting device.

### DETAILED DESCRIPTION OF ONE ILLUSTRATIVE EMBODIMENT

### Prior Art

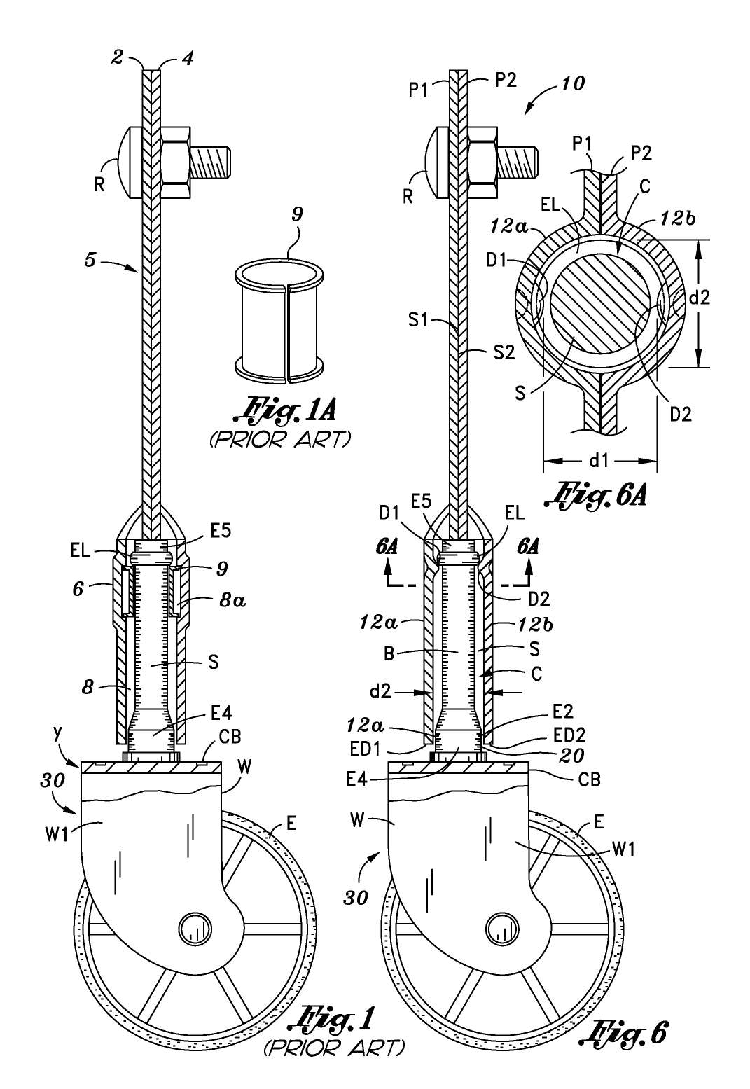

As shown in FIGS. 1 and 1A, a prior art wheel-mounting device 5 includes a pair of attached plates 2 and 4, each with an enlarged indentation 6. The plates 2 and 4, upon assembly, form a cavity 8 in which a shaft S of a wheel assembly 30 is seated. An enlarged diameter outer end 8a of the cavity 8 holds a spilt ring 9 (FIG. 1A) in which a free end E5 of the shaft S is placed. As shown best is FIG. 1, the wheel assembly 30 includes a yoke Y that supports a wheel E. The yoke Y comprises a crossbar CB having at opposed ends walls W1 and W2 (FIG. 5) between which the wheel E is mounted. The shaft S, positioned near or at the middle of crossbar CB, is substantially at a right angle with respect to the crossbar. The shaft S may have its terminal end E4 fixedly attached to the crossbar CB or mounted to rotate.

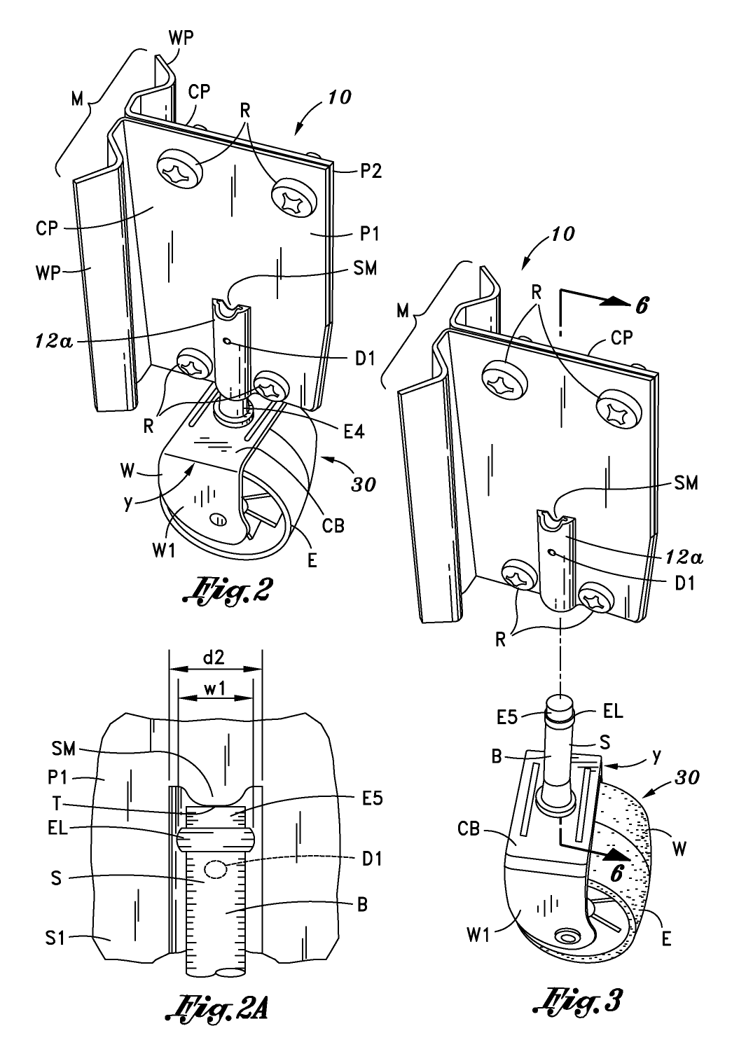

FIGS. 2 through 7

As shown best in FIGS. 2 through 6, one embodiment of my wheel-mounting device is generally designated by the numeral 10. My wheel-mounting device 10 eliminates the spilt ring 9 used in the prior art wheel-mounting device 5 to hold the shaft S of the wheel assembly 30 in place thereby reducing the cost by eliminating the spilt ring 9 and lowering the time to assemble my device.

This embodiment of my wheel-mounting device 10 includes a pair of plates P1 and P2 that hold the wheel assembly 30 in position. The plates P1 and P2 are substantially mirror images of each other and have a generally L-shaped configuration with a carrier portion CP and a wing portion WP. Each wing portion WP is substantially at 90 degrees with respect to the carrier portion CP.

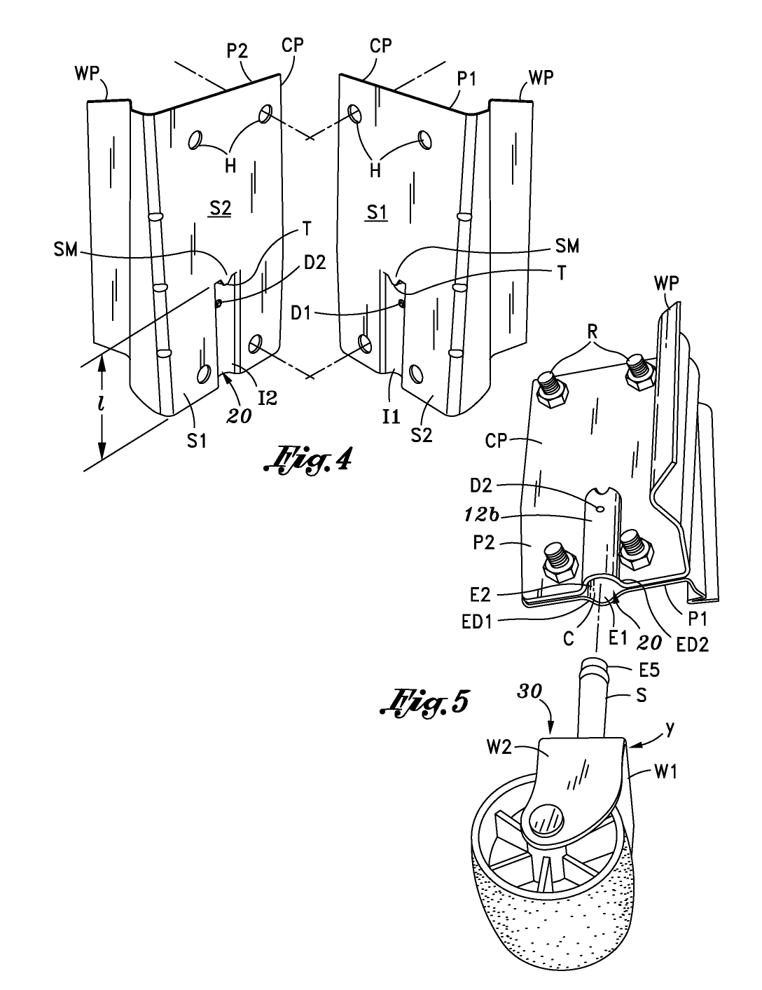

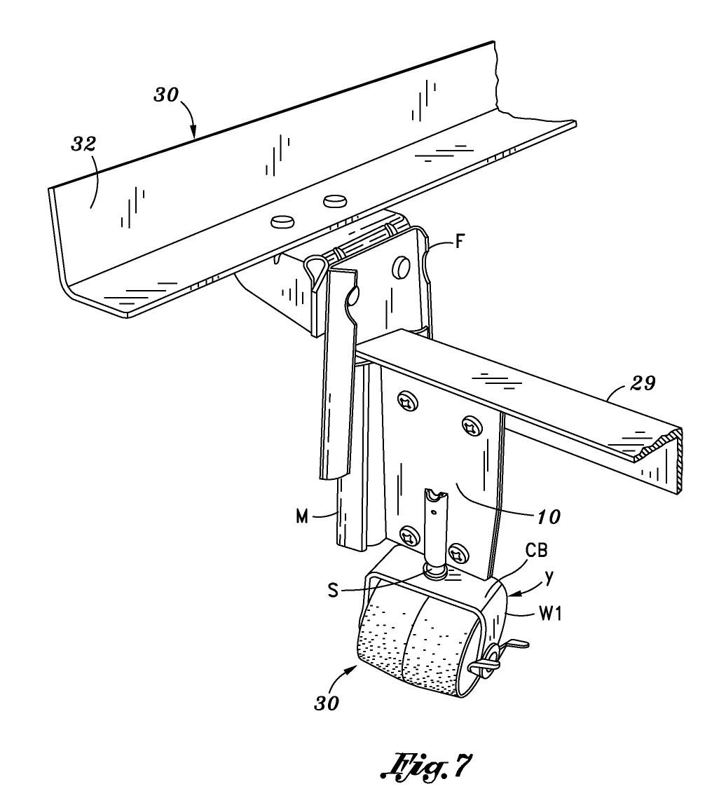

The plates P1 and P2 are manufactured from flat metallic sheets punch pressed and bent to into the L-shaped configuration. The sheets are placed into suitable shaped dies. As each metallic sheet enters and leaves a die, it will conform to the shape of the die. One die will form the plate P1, and another die will be the plate P2. As best shown in FIG. 4, each plate has therein indentations I1 and I2, respectively, and the inside surface of each indentations has a dimple element D1 and D2, respectively. A stop member SM is formed concurrently when the indentations I1 and I2 are formed, comprising a marginal portion within the body of plates P1 and P2 inward of the dimple elements D1 and D2. This stop member SM may have different shapes and, in this embodiment, terminates in an inwardly projecting pointed tip T. As shown in FIG. 4, the length l between the tip T and the open entryway 20 is slightly less than the length of the shaft S. The shaft may be slightly longer so the attached end E4, which may have a substantially cylindrical configuration, projects slightly from the cavity C. The diameter of the enlarged end E4 is greater than the diameter of a central main body B (FIG. 6) of the shaft 5 and is substantially equal to the diameter d2 (FIG. 2A) of the cavity C.

As shown best in FIG. 4, the carrier portions CP each have a substantially flat inside surface s1 and s2, respectively, and each flat surface s1 and s2 has therein an outwardly projecting semi-cylindrical wall 12a and 12b, respectively, with wall 12a including the indentation I1 and the wall 12b including the indentation I2. When the walls 12a and 12b are aligned and abutting as shown in FIGS. 3, 5, and, 6, they form a cavity C having a substantially uniform diameter d2 (FIG. 6A) along substantially the entire length of the cavity. Within the cavity C the dimple elements D1 and D2 (FIG. 4) are aligned along a common line and project inwardly. As best illustrated in FIG. 5, the indentations I1 and I2 each include open external end portions E1 and E2 respectively at an edge ED1 and ED2 of the plates P1 and P2. The open external end portions E1 and E2 form the open entryway 20 of the cavity C. As best shown in FIG. 5, upon attachment of the plates, the shaft S of the wheel assembly 30 is seated in the cavity C with a lower end E4 extending from the open entryway 20 of the cavity.

Once the plates P1 and P2 are joined, as shown in FIG. 5, the flat inside surfaces s1 and s2 abut, the indentations I1 and I2 form the cavity C, and the wing members form a male connector element M. Also, the open external end portions E1 and E2 of the indentations I1 and I2 form the open entryway 20 along the edges ED1 and ED2 of the abutting and attached plates P1 and P2. The dimple elements D1 and D2 within the cavity C are along a common line and point toward each other and are separated by a distance d₁ (FIG. 6A) upon attachment of the plates P1 and P2. As best shown in FIGS. 4 and 5, the plates P1 and P2 may be held together with fasteners such as, for example, rivets, nuts and bolts or other attachment means R, passing through holes H at or near the corners of the carrier portions of the plates P1 and P2. The wheel assembly 30 may be connected to the wheel-mounting device 10 either before or after the plates P1 and P2 are fastened together with the fasteners R. The dimple elements D1 and D2 function as a bearing for the shaft S and the lower cylindrical end E4 also functions as a bearing for the shaft.

In one method of assembly, the shaft S of the wheel assembly 30 is inserted through the open entryway 20 into the cavity C after the plates P1 and P2 are joined. As best shown in FIGS. 2A and 6A, once the shaft S enters the open entryway 20, it is forced inward until an enlarged element EL of the shaft passes the dimple elements D1 and D2. This enlarged element EL may be a raised annular element along the circumference of the shaft S near the upper free end E5 of the shaft. The enlarged element EL has a width w₁ dimension greater than the distance d₁ (FIG. 6A) between the dimple elements but less than the diameter d2 (FIG. 2A) of the cavity C. Once the enlarged element EL passes the dimple elements D1 and D2, these dimple elements will prevent the shaft S from dislodging from the cavity C to hold the wheel assembly 30 in a secure manner, preventing it from moving lengthwise out the open entryway 20. In other words, the relative positions of the stop member SM, the dimples D1 and D2, and the enlarged element EL prevent the shaft S from sliding longitudinally within the cavity C.

An alternate method of assembly is to place the shaft S between unattached plates P1 and P2 and within the indentations I1 and I2 so the free end E5 abuts the tip T of the stop member SM. Then the plates P1 and P2 are attached together using, for example, nuts and bolts.

As shown in FIG. 7, the wheel-mounting device 10 is attached to a crossbar 29 of a bed frame 30. A bed rail 32 of the frame 30 is connected to the crossbar 29 by a female connector element F. The male connector element M slides into the female connector element F in a mating-like fashion and the assembled plates P1 and P2 may be fastened to the crossbar 29.

### SCOPE OF THE INVENTION

The above presents a description of the best mode contemplated of carrying out my swivel wheel-mounting device, and of the manner and process of making and using it, in such full, clear, concise, and exact terms as to enable any person skilled in the art to which it pertains to make and use my wheel-mounting device. My wheel-mounting device is, however, susceptible to modifications and alternate constructions from the illustrative embodiment discussed above which are fully equivalent. Consequently, it is not the intention to limit my swivel wheel-mounting device to the particular embodiment disclosed. On the contrary, my wheel-mounting device is to cover all modifications and alternate constructions coming within the spirit and scope of my swivel wheel-mounting device as generally expressed by the following claims, which particularly point out and distinctly claim the subject matter of my swivel wheel-mounting device:

1. Wheel-mounting device comprising
a pair of plates each having a substantially flat surface,
said flat surface of each plate having therein an elongated indentation including an inwardly projecting dimple element,
said indentations each including an open external end portion at an edge of the plate in which the indentation is situated,
said plates being attached together with said flat surfaces abutting and the indentations being aligned and facing each other to form a cavity upon attachment of the plates,
said dimple elements being aligned along a common line and pointing towards each other and separated by a predetermined distance upon attachment of the plates,
said open external end portions of the indentations forming at an outer end of the cavity an open entryway along the edges of the abutting and attached plates.

2. The wheel-mounting device of claim 1 where the plates are substantially mirror images.

3. The wheel-mounting device of claim 1 where each plate comprises a carrier portion and a wing portion along an outer edge of the carrier portion.

4. The wheel-mounting device of claim 3 where each wing member is substantially at 90 degrees with respect to the plate.

5. A wheel-mounting device comprising
a pair of metallic plates each having a substantially flat surface,
an elongated indentation in the flat surface of each plate including an inwardly projecting dimple element, said indentation and dimple element formed by punch pressing the metallic plate,
said indentations being substantially mirror images and each indentation including an open external end portion at an edge of the plate in which the indentation is situated,
said plates being attached together with said flat surfaces abutting and the indentations being aligned and facing each other to form a cavity upon attachment of the plates,
said open external end portions of the indentations forming at an outer end of the cavity an open entryway along the edges of the plates,
said dimple elements upon attachment of the plates being aligned along a common line and pointing towards each other, the aligned dimple elements being at or near an inner end of the cavity and separated by a predetermined distance that enable the dimple elements to prevent a wheel shaft from moving lengthwise out the open entryway when said shaft is received within the cavity.

6. The wheel-mounting device of claim 5 where a portion of the attached plates form a stop member at an inner end of the cavity opposite the open entryway to limit inward movement lengthwise of the shaft.

7. The wheel-mounting device of claim 1 where each plate has a wing member formed by bending the metallic plate substantially at 90 degrees, said wing member facilitating detachably connecting the wheel-mounting device to a bed frame.

8. A combination of a wheel-mounting device and a wheel where the wheel-mounting device comprises
a pair of plates each having a substantially flat surface,
said flat surface of each plate having therein an elongated indentation including an inwardly projecting dimple element,
said indentations being substantially mirror images and each indentation including an open external end portion at an edge of the plate in which the indentation is situated,
said plates being attached together with said flat surfaces abutting and the indentations being aligned and facing each other to form a cavity upon attachment of the plates,
dimple elements being aligned along a common line and pointing towards each other and separated by a predetermined distance upon attachment of the plates,
said open external end portions of the indentations forming at an outer end of the cavity an open entryway along the edges of the plates, and
the wheel being mounted to the lower end of the shaft and comprising
an elongated shaft seated in the cavity and having an upper end portion including an enlarged element having a width dimension greater than said predetermined distance between the dimple elements and a predetermined length that enables a lower end to extend from the open entryway,
said enlarged element being at or nearby the inner end of the cavity and inward of the dimple elements with the plates attached to hold said shaft within the cavity and prevent movement lengthwise out the open entryway.

9. The combination of claim 8 where a portion of the attached plates form a stop member at an inner end of the cavity opposite the open entryway to limit lengthwise inward movement of the shaft.

10. The combination of claim 8 the shaft includes a central main body portion with a diameter less than said predetermined distance between the dimple elements and the enlarged element is a substantially annular member having a diameter greater than the diameter of the main body portion, and the lower end has a diameter greater than said predetermined distance between the dimple elements and greater than the diameter of the main body portion.

11. The combination of claim 10 where the cavity has a substantially cylindrical configuration with a predetermined diameter and the annular member and the lower end of the shaft have a diameter less than the predetermined diameter of the cylindrical cavity.

12. The combination of claim 10 where the plates include a plurality of punched pressed holes therein and fasteners passing through said holes.

13. The combination of claim 12 where the holes are at or nearby corners of the said plates.

14. A bed frame including
at least one leg having a wheel assembly mounted thereto by a mounting device,
said mounting device comprising
a pair of plates each having a substantially flat surface,
said flat surface of each plate having therein an elongated indentation including an inwardly projecting dimple element,
said indentations each including an open external end portion at an edge of the plate in which the indentation is situated,
said plates being attached together with said flat surfaces abutting and the indentations being aligned and facing each other to form a cavity upon attachment of the plates,
said dimple elements being aligned along a common line and pointing towards each other and separated by a predetermined distance upon attachment of the plates,
said open external end portions of the indentations forming at an outer end of the cavity an open entryway along the edges of the abutting and attached plates, and
each said wheel assembly comprising
an elongated shaft seated in the cavity and having an upper end portion including an enlarged element having a width dimension greater than said predetermined distance between the dimple elements and a predetermined length that enables a lower end to extend from the open entryway,
said enlarged element being at or nearby the inner end of the cavity and inward of the dimple elements with the plates attached to hold said shaft within the cavity and prevent movement lengthwise out the open entryway, and
a wheel mounted to the lower end of the shaft.

15. A plate for mounting a wheel assembly including a shaft having a predetermined length and an enlarged element a predetermined distance from a terminal end of the shaft, said plate being formed from a single piece of substantially flat sheet metal that is bent into a substantially L-shaped configuration and comprising
a carrier portion and a wing portion that are integral along a common junction and substantially at a right angle with respect to each other,
said carrier portion having a substantially flat inside surface,
said flat surface having therein an elongated indentation including an inwardly projecting dimple element,
said indentation including an open external end portion at an edge of the plate and having a length that is substantially equal that of the length of the shaft,
a dimple element pointing inward and at a predetermined distance from said edge that is substantially equal to the distance the enlarged element is from the terminal end of the shaft.

16. A method of manufacturing a wheel-mounting device comprising
providing a pair of plates that are substantially mirror images, each plate having a substantially L-shaped configuration and being manufactured from substantially flat metallic sheets punch pressed and bent into said L-shaped configuration, each plate including a wall with an indentation therein, said indentation including an inwardly projecting dimple element and having an open end along an edge,
fastening together said plates with the walls of the plates abutting each other with the indentations aligned to form a cavity having along the edges an entryway adapted to receive a shaft of a wheel,
said dimples being aligned opposite each other and spaced apart to hold a shaft of a wheel in the cavity.

17. The method of claim 16 where the shaft is inserted into the entryway of the cavity after fastening the plates together.

18. The method of claim 16 where the shaft is placed between the plates and then the plates are fastened together.
